(19) United States
(12) Patent Application Publication
(10) Pub. No.: US 2015/0084859 A1
(43) Pub. Date: Mar. 26, 2015

(54) System and Method for Recognition and Response to Gesture Based Input

(71) Applicant: Yair ITZHAIK, Nahariya (IL)

(72) Inventor: Yair ITZHAIK, Nahariya (IL)

(21) Appl. No.: 14/493,642

(22) Filed: Sep. 23, 2014

Related U.S. Application Data
(60) Provisional application No. 61/881,161, filed on Sep. 23, 2013.

(51) Int. Cl. G06F 3/01; G06K 9/00

(52) U.S. Cl. CPC G06F 3/017; G06K 9/00355; G06K 9/00375; G06K 2009/00395
USPC 345/156; 382/103

(57) ABSTRACT

A method for user identification by using multiple sensing devices configured for sensing at least one characteristic associated with user's gestures. The method includes the steps of: receiving data from the sensing devices indicative of at least one gesture of a user; identifying at least one gesture and at least one characteristic thereof from the data from each sensing device, using at least one gesture recognition analysis process; and identifying the user according to the identified at least one gesture and characteristics, wherein these steps are carried out via at least one processor of at least one user device.

### FIELD OF THE INVENTION

The present invention generally relates to gesture recognition and more particularly to system and methods for recognizing and responding to gestures based input.

### BACKGROUND OF THE INVENTION

Gesture recognition is defined herein as identification of motion related characteristics of one or more body parts of a human subject such as body, limb(s), palms and fingers, lips, eyes, eyelids and the like.

Many mathematical models have been developed to identify bodily gestures such as hand movements, limbs and/or torso movements for various utilizations such as for sign language translation and the like using various devices such as cameras for detecting movements of human body parts. These models are configured to receive output data from the sensor and identify the gestures by identifying the location of one or more body part at each given timeframe or to identify more general gesture related information such as a fall, a swing and the like using data acquired by movement detectors such as an accelerometer, for instance.

More and more computerized devices such as PCs, laptops, tablet devices and smartphones are equipped with sensors such as cameras, accelerometers and the like as well as interface input devices such as touch screens, keyboards, computer mice, audio input devices such as microphones and the like allowing thereby visual, audio and other sensory detection and data acquisition and input.

### SUMMARY OF THE INVENTION

According to one aspect of the invention, there is provided a method for user identification by using multiple sensing devices configured for sensing at least one characteristic associated with user's gestures. The method includes the steps of: receiving data from the sensing devices indicative of at least one gesture of a user; identifying at least one gesture and at least one characteristic thereof from the data from each sensing device, using at least one gesture recognition analysis process; and identifying the user according to the identified at least one gesture and characteristics, wherein these steps are carried out via at least one processor of at least one user device.

According to another aspect of the invention, there is provided a method for identification of signs including: sensing at least two types of inputs one of which is a physical gesture, said inputs are performed by a subject simultaneously, wherein said sensing is carried out by using at least one sensing device; receiving the at least two inputs simultaneously sensed; processing the received simultaneously sensed inputs for identifying at least one sign associated therewith by cross-matching theses recorded inputs, wherein the processing is carried out by using at least one computer processor.

According to yet another aspect of the invention, there is provided a method for gesture recognition and movement tracking in space and translation including: sensing one or more gestures performed by a subject, not limited for tracing or tracking of movement/.motion in space, using at least one or more sensing device, that capture and measure one or more activities occurring in the exact same time or in the same time frame, process and applying cross-match if required to the input of the sensors that measurements which capture the same gesture and/or movement in space.

Recognizing each of the gestures by identifying characteristics of each sensed gesture; identifying an activity that is associated with the recognized one or more gestures in an injective manner; and operating the identified activity upon identification thereof.

The activity may be one of: a computer function directly associated with the identified at least one gesture or a computer function indirectly associated with the gesture(s) such as a function that is associated with a corresponding mouse function or mouse movement's traced in space, where the computer mouse function or traced measurement result operates an activity in relation to the status of the computer(e.g.

which program is opened at that particular moment and the like), or as another example,

According to yet another aspect of the invention, there is provided a method for gesture recognition and translation including: sensing one or more gestures performed by a subject, using at least one sensing device; recognizing each of the gestures by identifying characteristics of each sensed gesture; identifying an activity that is associated with the recognized one or more gestures an injective manner; and operating the identified activity upon identification thereof. The activity may be one of: a computer function directly associated with the identified at least one gesture or a computer function indirectly associated with the gesture(s) such as a function that is associated with a corresponding mouse function where the computer mouse function operates an activity in relation to the status of the computer(e.g. which program is opened at that particular moment and the like).

According to yet another aspect of the invention is provided a method for identification of motion tracking/tracing of an object. The method comprising the steps of: measuring motion of a single object motion by at least two motion capture sources, wherein one motion capture source, captures the motion of the object from a distance and a second sensor is associated or attached or embedded to said objection, receiving the at least two inputs simultaneously sensed and processing said received simultaneously sensed inputs for identifying at least one motion track/trace by cross-matching these recorded inputs, said processing is carried out by using at least one computer processor.

According to some embodiments of the invention, is provided a system for user identification comprising: multiple sensing devices connected by wireless data network and associated with the same user and User Identification Application residing on computerized device : for receiving data from multiple sensing devices indicative of at least one gesture of a user, identifying at least one gesture and at least one characteristic thereof from the data from each sensing device, using at least one gesture recognition analysis process and identifying a code associated with the user according to the identified at least one gesture and characteristics thereof.

### BRIEF DESCRIPTION OF THE DRAWINGS

FIG. 1 is a flowchart schematically illustrating a process and method for user identification based on gesture recognition, according to some embodiments of the present invention.

FIG. 2 is a block diagram schematically illustrating a system for gesture recognition, according to some embodiments of the present invention.

FIG. 3 is a flowchart schematically illustrating a process and method for cross-matching of multiple inputs based, inter alia, on gesture recognition for lingual sign recognition and interpretation, according to some embodiments of the present invention.

FIG. 4 is a flowchart schematically illustrating a process and method for cross-matching of multiple inputs each input is a gesture of different body parts mainly hand movement and lips movement for lingual signs identification and verification, according to some embodiments of the present invention.

FIG. 5 shows an illustration of a right human hand.

FIGS. 6A-6E show different hand gestures for being translated into different equivalent computer mouse actions, according to some embodiments of the invention: FIG. 6A shows an Open Klikegest gesture; FIG. 6B shows a Closed Klikegest gesture; FIG. 6C shows a Moving Open Klikegest gesture; FIG. 6D shows a Middle-Finger Closed Klikegest gesture; FIG. 6E shows a Wrapped Klikegest gesture.

FIG. 7 is a flowchart schematically illustrating a process and method for cross-matching of single motion tracing of an object from different motion captures sources according to some embodiments of the present invention.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides methods and systems for operations that are based on gesture recognition.

The term “gesture” in this document refers to any kind of static or dynamic positioning of any one or more body parts of a human or non-human subject including a static pose and/or an entire movement of one or more body parts within a short period of time. For example a gesture may be considered as a posture/pose of body parts such as hand(s) posture, lips posture, torso posture, leg(s) posture, facial expression and the like or a combination of at least two of them such as a combination of the posture of the hands and the lips or a combination of the posture of the legs and the torso etc. In another example, a gesture is a movement of the lips or hands or a hand holding object such as smartphone or smartwatch or any other body part or a combination of body parts within one or more predefined periods of time (e.g. a few seconds or a fraction of a second such as a few milliseconds).

According to some embodiments of the invention, gestures can be detected by any sensing device and method known in the art such as, but not limited to, 2D or 3D movement capturing sensors such as but not limited to 2D or 3D stills or video camera, and/or by sensing hands' movements when holding a mobile device such as a tablet device or a smartphone for example having one or more orientation sensors, such as an accelerometer, a gyroscope, a compass, and/or a touch-screen enabling sensing finger or fingers or a digitized pen movements thereover.

The gestures performed by the one or more users may be detected via sensing devices embedded in one or more computer devices such as PC computers, laptops, smartphones, tablet devices, digital watch, pendant or any other wearable device such as accessories that produce spatial trace like ring, etc, and the like using only one of the computer devices for processing the data arriving from the one or more sensing devices or using the processor(s) of more than one of the devices used for sensing.

The data from all the sensing devices used for sensing gesture based input and optionally other input data such as data from audio input sensing devices (e.g. microphones and other transducers), text input and the like is then processed for identifying the one or more gestures and other information inputted by the one or more users for various processes and purposes such as for user identification, computer functions identification (having gesture recognition used as a virtual keyboard or mouse for instance), lingual signs identification and the like.

According to some embodiments of the invention, a system includes multi-devices having a main device such as but not limited to PC, TV, or a point-of-sale stand, a public working station, etc. and other one or more devices or net entities that carry (among other data) user's personal data, such as but not limited to smartphones, tablet devices, other PCs, TVs, user's disk-on-key, or/and hotspots with unique IP, or a central site network, that carry among other data some details of user's personal data, while main device and the other personal devices or net entities that include sensors for detecting human input such as for example but not limited to a 3D sensor or standard video or stills camera, a microphone, a fingerprint reader, keyboard for textual input, digitizer, scanner, and others, that can capture human input such as 2D or 3D images, videos, gestures, text inputting, fingerprint, pupils stamp and pupil movement and others, and can recognize, process and generate responses to this input where those responses generate a set of system, activities or consecutive ordered system activities that consist among others but not limiting , procedures of measuring movement trace in space or authentication user's identification or/and confirmation of password.

The present invention, in some embodiments thereof, provides methods and systems for user identification by (a) receiving data from multiple sensing devices such as a 2-dimensional (2D) or 3D camera and an accelerometer device, indicative of at least one gesture performed by a user; (b) identifying the at least one gesture and at least one characteristic thereof from the data arriving from each sensing device, using at least one gesture recognition analysis process carried out by a processor; and (c) identifying the user according to the identified at least one gesture and characteristics thereof. In some embodiments the multiple sensors sense a single same gesture that was performed by the user and the identification and authentication of the user is done by comparing the gesture identified through analysis of the data from one sensor to the gesture identified by analyzing the data from the other one or more sensors. This means that if all sensors sensed the same gesture, the user is identified by the identification of the actual gesture characteristics and authenticated by the positive comparison between the sensors. The sensors may be embedded in one or more devices such as in one or more smartphones, tablet devices, personal computers and the like or each embedded in a different device. For example the camera may be embedded and operable through a PC computer while the accelerometer embedded and operable in a smartphone device, where the processing of the data from the multiple sensors is carried out at one device or only one of the devices.

In other embodiment the user identification is done by requiring that the user performs a predefined sequence of a series of predefined gestures (either static or dynamic) while one or more sensors detect characteristics of this performed sequence of gestures and then all data is processed at a single processor for identifying the gestures and sequence thereof for identifying the user e.g. by associating a user code with the identified gestures sequence.

The present invention, in other embodiments thereof, provides methods and systems for identification of lingual signs such as phonemes, syllables, words sentences and the like by (a) sensing at least two types of inputs one of which is a type of a physical gesture, said inputs are performed by a subject simultaneously, wherein said sensing is carried out by using at least one sensing device; (b) receiving the at least two inputs simultaneously sensed; and (c) processing said received simultaneously sensed inputs for identifying at least one lingual sign associated therewith by cross-matching theses sensed inputs, said processing is carried out by using at least one computer processor.

The term “cross-matching” means that the input of at least two types of inputs one of which is a type of a physical gesture (such as gesture) of a first type such as hand sign language gesture is matched with input of a simultaneous different type such as a simultaneous lip movement (another type of gesture) or audio input of the lingual sign to identify and verify the lingual sign associated therewith.

The term “lingual sign” refers to any type of sign or part thereof that has a lingual meaning such as a word, a sentence, a phoneme or a syllable all parts of a word that can be understood and interpreted.

This method and system can be used for translating a person speaking into sign language for deaf people by identifying what another person is saying through their lips movement as well as through voice recognition using audio input signals interpreted via voice recognition algorithms The speech parts such as words identified through voice recognitions technique using signals from an audio system such as a microphone can be verified by comparing the identified word from the audio data to the word identified through lip-movement recognition from video data of a video camera filming the user while speaking. In another example, the two inputs may be lip-movement combined with sign language gesturing for translating a speaking deaf person into written text. In another examples, that can be used for anyone and not only for people with disabilities, the two inputs may be audio input signals interpreted via voice recognition algorithms and text interpreted via handwriting-gesture recognition algorithms from handwriting drawing input (done as gesture on touch screens or by gestures in the air) or of text that is inputted on physical or virtual keyboards by moving hands or fingers on a touch screen or by gestures in the air.

According to some embodiments of the invention, user's unique parameters can be but not limiting user's face recognition parameters or user's voice authentication using user's voice stamp , or user's audio password said in user's voice and stored without processing of voice recognition, or user's text password of word or sentence that was keyed or recorded and voice recognized before storing in user's data, or user's text password of word or sentence, or one random word of the sentence that in real-time during the authentication process, is being keyed or recorded and voice recognized, user's unique set of ordered or randomly done gestures, or user's hand movement stamp captured by camera and sensors, or user's unique cryptic call for actions notification sent to the device from users' database server or cloud.

According to some embodiments of the invention, the system can be configured to output the identified lingual signs or sequences thereof via audio and/or visual output means and techniques such as by presenting text representing the identified words via one or more screens and/or by outputting audio signals of the spoken words via audio speakers.

According to yet another aspect of the invention, the systems and methods are configured simply for identification of gestures for various functionalities and purposes by having a database structure in which each gesture is directly associated with a computer function or indirectly with any other computer related translation in an injective manner. In one embodiment, a set of predefined fingers gestures is associated with computer mouse functions such as double click of the right mouse button, cursor movements over the screen and the like wherein each movement of the fingers or each fixed pose thereof is first sensed via a sensor such as a 2D or a 3D camera or a touch screen and then translated in the computer processor to a computer mouse type of function. This allows using gesture recognition as a 3D virtual computer mouse requiring no actual mouse device but simply using the computer camera for sensing the hand and finger movements in 3D space. Some gestures may be translated as lifting of the mouse to relocate the curser for instance.

In other embodiments, a movement of the finger can be translated into a symbol such as a letter wherein each symbol is translated into a computer function in an injective manner. For example gesturing the letter “S” with one's finger may be translated in the processor into a “save” function, while gesturing the letter “W” may trigger the function of opening a new “WORD™” document window, etc.

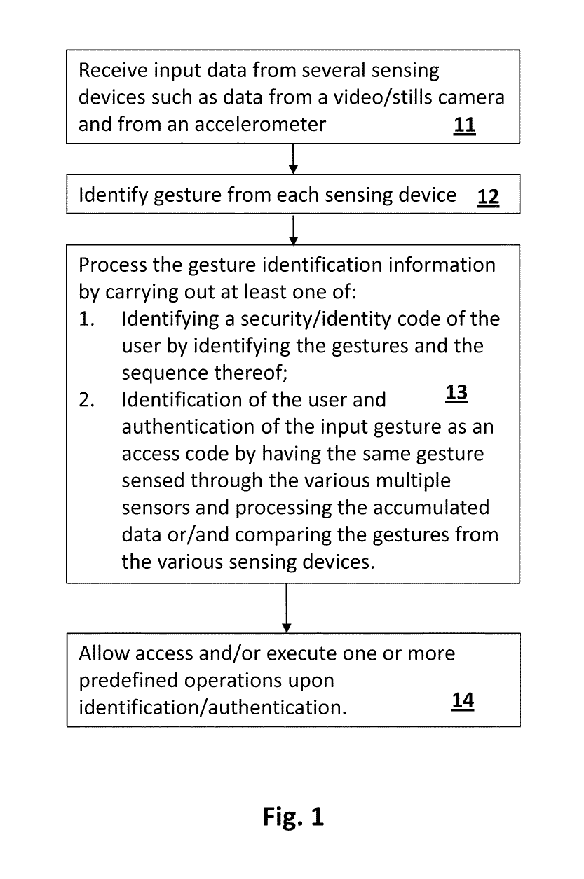

Reference is now made to FIG. 1, which is a flowchart schematically illustrating a process and method for user identification based on gesture recognition, according to some embodiments of the present invention. the process and method includes receiving input data from several sensing devices 11 such as, for example, receiving video data from a video camera and sensor data from an accelerometer both configured for detection of one or more characteristics of a gesture performed in their vicinity by a user. The user may perform any gesture random or predefined or a predefined sequence of gestures in a predefined manner and order, such as but not limiting the user own signature, in front of the video camera and/or while holding a device having the movement sensors such as accelerometer, or/and gyroscope or/and compass, a for detecting some acceleration and orientation characteristics of the gesture movements. The detected (e.g. captured) gesture or sequence thereof is processed for identifying unique personal characteristics identified by using a processor operating a predefined one or more algorithms for identifying each gestured detected in each sensing device. E.g. image processing algorithm for identifying the gesture captured in the video camera that is configured for processing the video data and another algorithm that is configured to receive data from for example the accelerometer and identify the gesture therefrom.

In these embodiments the gesture or gestures sequence is used as an identification and authentication code for achieving access for example or executing computer or other machine functions, in some cases, without requiring physical contact with an input interface device.

The user identification requires the user to perform the gesture or the gestures sequence in a location and manner that allows all sensing devices to simultaneously detect all the performed one or more gestures or in a manner that allows each gesture of the sequence to be detected by a different sensing device.

Each gesture is then identified 12 by one or more processors using gesture recognition algorithms that are associated with each sensing device's output data and detection manner for identifying the gesture detected in each sensing device separately and optionally, in case of a sequence of gestures the timing of each gesture in the sequence.

There are several possible identification processes that are optional using these devices and processors 13: (a) having each gesture of the sequence detected by a different sensing device associated with its timing that relates to the specific gesture's chronological place in the sequence wherein the processing of the resulting gestures includes identifying the sequence of gestures from each sensing device's timing and movement related data; (b) having the one gesture or sequence of gestures detected simultaneously by all the sensing devices and identifying the gesture(s) from all sensing devices and using one of the sensing device's (i.e. the first sensing device's) identified gesture or a gestures sequence for user identification and authenticating the identified identity by processing the accumulated data or/and comparing the identified gesture or sequence from the first sensing device to the identified gesture/sequence from the other sensing device(s). The identification and optionally authentication of the user may be used for any user identification and authentication purpose such as for access allowance, machine operation, other executions of computer functions and the like 14.

According to some embodiments all the sensing devices are embedded or operable through a single computer device such as a laptop, PC, smartphone, tablet device, mobile phone and the like. For example, a smartphone having both a camera and an accelerometer for device orientation detection may both be embedded in the smartphone wherein to identify the user and authenticate his/her identity the user may be required to first perform a first gesture in front of the smartphone's camera and then a second (different) gesture that involves holding the smartphone and changing its orientation. In this example, the smartphone's processor (e.g. through a specially installed or downloaded software), identifies the first gesture as being a first gesture and identifies the actual gesture (e.g. combining fingers of both hands) and then the second gesture (e.g. rotating the smartphone a half-spin clockwise) where the identification of the sequence of gestures in the right order allows identification of the particular user.

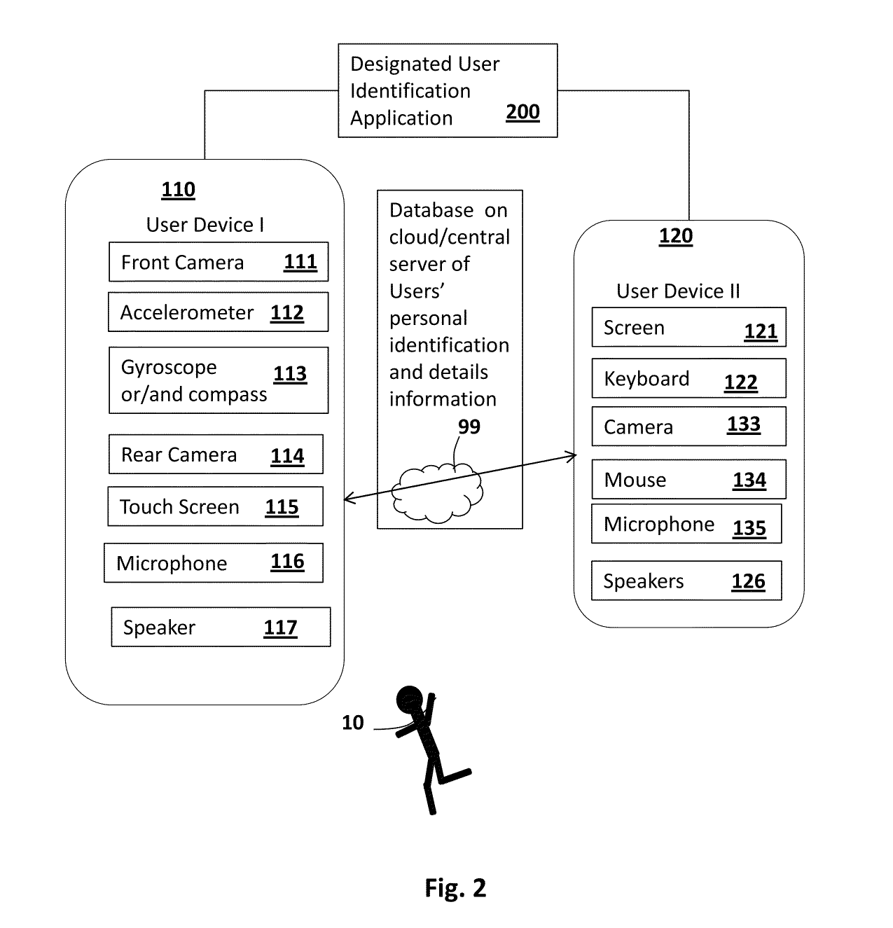

FIG. 2 is a block diagram schematically illustrating a system for gesture recognition using sensing devices operable through multiple computer user devices for sensing and identifying gestures, according to some embodiments of the present invention. The system comprises a designated identification application 200 operable via at least a first user device 110 (in this example a smartphone or tablet device) and may use sensing device of other computer devices such as a second user device 120 (in this example a PC computer). Each of the computer user devices 110 and 120 is configured for operating various input, output and sensing devices connected thereto and/or embedded therein and are configured to receive, output and process input and output data from these devices. For example, the first user device 110 has a front camera 111 which can be used both as stills and video camera; an accelerometer 112; an accelerometer 112 for sensing orientation of the user device and may also be used for sensing sudden movements of the user device such as sudden fall and the like; optionally a gyroscope or/and compass 113 also for sensing orientation of the user device; a rear camera 114; a touch screen 115; a microphone 116; and a speaker 117.

The second computer user device 120 includes or operates a screen 121; a keyboard 122; a computer mouse 134; a camera 133 which can be used both as a stills as well as a video camera; a microphone 135 and one or more speakers 126.

According to some embodiments, the designated application 200 is configured for being downloaded or installed at one or more of the computer user devices 110, 120 where one or more sensing devices thereof is used for detecting gestures and one or more input devices thereof is used for allowing the user to input data therefrom for various purposes of the system. The designated application 200 is configured and designed to allow using at least one computer user device 110/120 using the sensing and input devices as well as processor thereof for gesture detection and recognition, respectively and optionally, for using the output device(s) thereof for outputting data and information relating to the identified gestures.

According to some embodiments the designated application 200 is configured for one or more of the following purposes: (gesture recognition for user identification using any one or more of the methods for identifying a user via gesture recognition described above); gesture recognition for identification of lingual signs and/or for operating computer functions thereby.

To use sensing and input devices of multiple computer user devices using a processor of only one of them to process the data requires transmission of data from one user to device to other over one or more communication links using transmission and receiving devices often embedded in these user devices. The designated application 200 is further then configured for operating data transmission modules for receiving data from another user device.

For example, the user may perform a gesture or a series of gestures predetermined and known in the system in front of video camera operable through his/her mobile device (e.g. smartphone) or a separate user device such as a PC verifying that the camera captures his/her hand movements for instance. The camera images processing is configured to produce, for instance, the coordinates of one or more points over the user's hand in relation to time i.e. for each point of the hand an (xᵢ, yᵢ, zᵢ) coordinated associated with a respective time indication “tᵢ”. The gesture(s) is(are) performed by the user while holding his/her smartphone with the designated application operated thereby allowing movement sensors of the smartphone such as the gyroscope accelerometer and compass measure other parameters of the movements of the same hand at the same time that the camera captures the movement of the hand. This allows computing more accurately the trace of the movement in space or/and identification of the gesture(s) itself i.e. the course of the hand movement(s) and other such features of the gesture(s) in a more precise and/or detailed manner for improving the ability of the system to capture user's movement trace in space or user identification and/or authentication. In some cases there is not requirement to identify the gesture from each sensor or a group thereof but simply use the multiple sensing devices for improving the computing of user's movement trace in space or the gesture recognition by having an abundant of information associated with the same gesture performed from those various devices each capable of measuring a different aspect of the movement.

According to some embodiments of the invention, the user can register a sequence of ordered or a set of non-ordered activities as his basic password, and in the authentication phase the user has to repeat this sequence of ordered activities or this set of not ordered activities, together with other random activities of same type (gestures or/and voice or/and text written words, and as like), and the system confirms the user's authentication if the user includes in his activities those of the basic password, and if the user never did this same sequence/set before, in the positive confirmation case the system remembers and stores in the user's password information the sequence/set that was done (together with the random activities) for future process. This method prevents the easy duplication of for example a password of gestures that can easily be duplicated as is.

According to some embodiments of the invention, the authentication processes can be done on main device or other personal devices or/and net entities and can involve but not limiting matching user's inputs and activities on main device with users' details stored on central users' database (on server/cloud) to identify the right one or confirm an identification of specific user.

According to some embodiments of the invention, the authentication processes done on main device or on the other personal devices or/and net entities can involve but not limiting matching user's inputs and activities on main device or on other personal devices with users' details that are found or generated on one of the other personal devices or/and net entities.

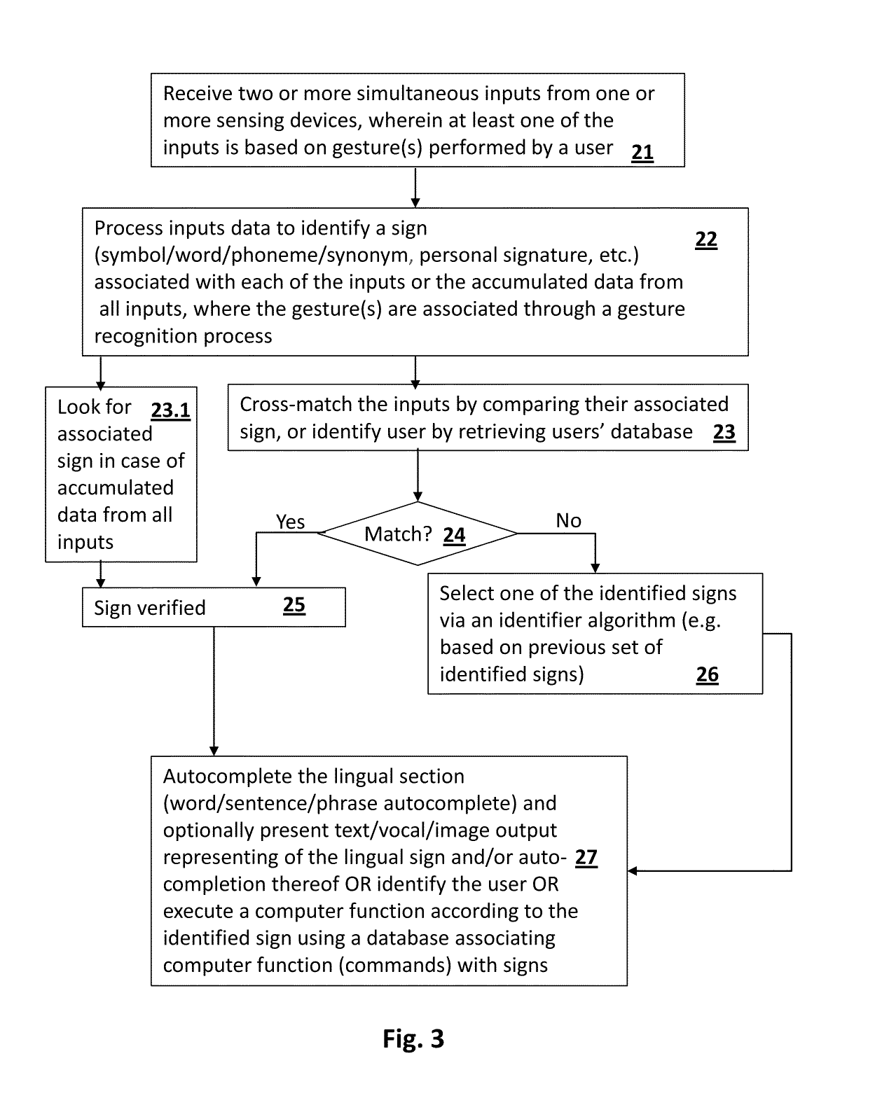

Reference is now made to FIG. 3, which is a flowchart schematically illustrating a process and method for cross-matching of multiple inputs based, inter alia, on gesture input for lingual sign recognition and interpretation, according to some embodiments of the present invention. This method includes receiving multiple inputs 21 substantially simultaneously performed by a user via multiple sensing and/or input devices of one or more computer user device such as for example, hand movement gesture of sign language accompanies by lips movement both sensed by using a video camera and/or voice input sensed by using a microphone. One of the inputs has to be a physical gesture (e.g. hands movements or lips movements and the like) where the other one or more inputs can either be gesture based or other such as audio, textual or any other type of user input. A designated application installed and operable via a processor of a computer user device may receive and processes this inputs data 122 for identifying the gesture(s) and the other inputs simultaneously performed by the user e.g. for identification of signs such as, lingual signs i.e. symbols, phonemes, syllables, words, personal signature, etc. or for identification of symbols associated with computer functions. The received and identified gestures and inputs are cross-matched for verifying that all the simultaneous inputs are identified as the same signs 23, in case all simultaneous inputs match 24, the sign is verified 25 and then used for either outputting thereof 27, or for executing computer functions thereby. In this example, given in FIG. 3 the process is used for signs identification and therefore, the identified sign is associated with previous consecutive identified signs for lingual autocompletion i.e. words/phrases/sentences autocompletion.

If there is not match 24, then a decision making algorithm may be executed 26 for deciding which of the identified inputs is the most likely and select this sign as the identified sign. For example, in case the two inputs include a hand gesture of sign language and lips movements the hand gesture recognition may be more likely to be more accurately identified and interpreted.

Additionally or alternatively the algorithm uses statistical knowledge and techniques to guess the most likely sign based on the previously identified signs, for example by implementing a weighting system, and the logical lingual identification or completion thereof taking into consideration the order of the previous identified signs. For example, in case of sign language utilization if one of the two inputs was identified as “it” and the other identified as “going” while the previous sentence parts were : do not take” the algorithm may select the word “it” as the more likely word due to the contextual order and logics.

In some embodiments, another input may be detected and only analyzed in case of a dilemma between two other non-matching inputs. For example, the two default inputs may be hands and lips movements (in case of sign language recognition and interpretation for instance) while an audio input is only used and interpreted when the two gestures do not match to the same sign.

Sign identification through gesture recognition may require, in some embodiments, the user to draw the sign in space where the sensors such as a video camera detects the hand movements thereof. The sign identification algorithm may be adapted to identify a 2D graphical sign from the 3D movement by identifying one or more items in the hand such as the index finger tip and then draw the image of the finger-tip rout over the space to identify the sign's graphical outline.

According to some embodiments, as illustrated in FIG. 3, once the simultaneous inputs' associated sign(s) is(are) identified 22, the sign can alternatively or additionally be verified by searching for an associated one or more signs through database and algorithms taking into consideration accumulated knowledge from all inputs 23.1.

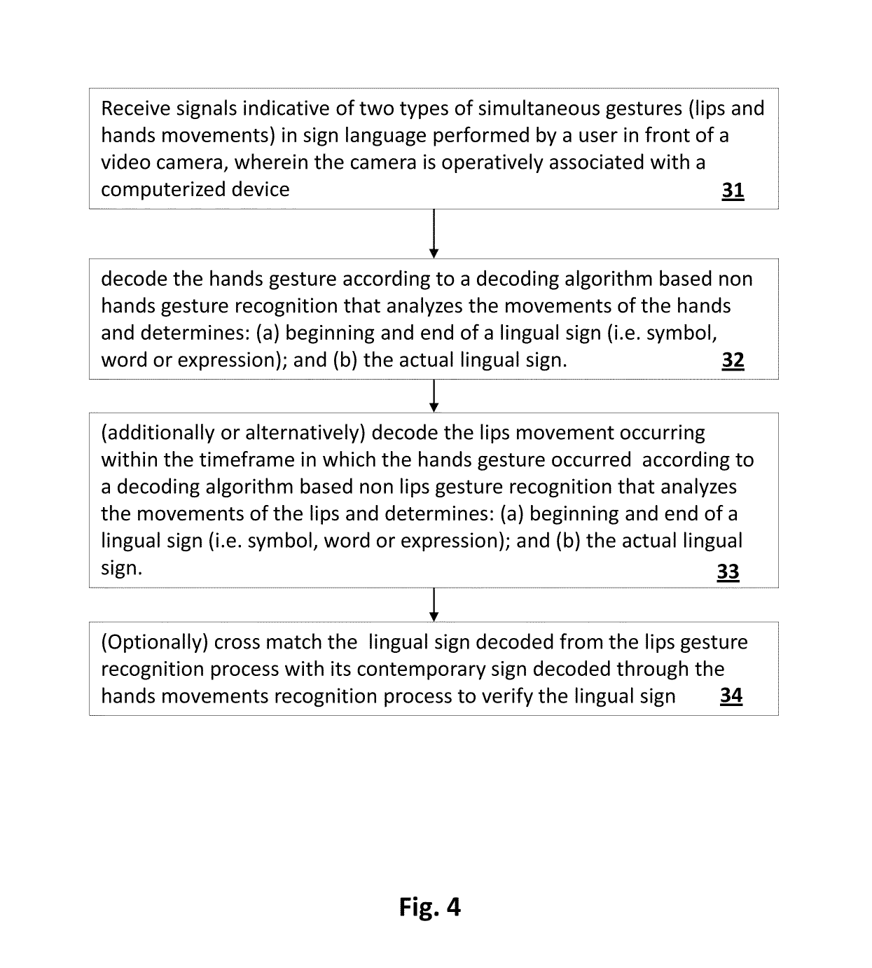

FIG. 4 is a flowchart schematically illustrating a process and method for cross-matching of multiple inputs each input is a gesture of different body parts mainly hand movement and lips movement for lingual signs identification and verification, according to some embodiments of the present invention. In this process the processor receives data indicative of simultaneous inputs from the multiple sensing and/or input devices 31 such as hands and lips movements gestures, where the hand movement gestures are in sign language and performed by the user simultaneously while speaking the words using lips movements in front of at least one camera positioned to capture both the hands movements as well as the lips movements of the user. The received data is then processed and analyzed using gesture recognition algorithms one adapted to decode hand movements gestures and the other to decode lips movements gestures 33-34. The decoding of the hands movements gesture results in identifying a first lingual sign (i.e. a phoneme, a syllable, a symbol, a word etc.) associated with the first input and the decoding of the simultaneous lips movements gesture results in identifying a second lingual sign associated with the second input. The first lingual sign may then be compared to the second lingual sign 35 for verification thereof, following the method described in relation to FIG. 3 for cross-matching the identified signs and optionally for auto-completion of text.

According to some embodiments, the identified and verified or selected sign may be presented over a screen and/or outputted via output means such as audio speakers and the like.

This technique for gesture recognition and verification by using cross-matching of multiple inputs may be used for many purposes and not only for sign language interpretation and auto completion of text but also for any utilization that can be made that used inputs of signs such as for executing computer functions, for text messaging, for operating machines and electric switches connected to computer means such as for gesture based electronic devices and appliances operation and the like.

According to some embodiments of the invention, gesture recognition can be used to replace the computer mouse for executing computer mouse known computer functions via gestures based input using sensing devices already existing in the user device such as camera, optical sensor and/or touch screen. This may be useful but not limited to mobile devices such as smartphones and tablet devices since mobilizing them with a mouse device is quite encumbers it mobility.

According to some embodiments, gesture recognition i.e. identification of each gesture of each type thereof (i.e. hands movement, lips movements, torso and limbs movements, palm and fingers and the like) is carried out using a database of known gestures indexing wherein each gesture index is associated either with a sign or with a function (e.g. computer code/commands for carrying out computer/electronic/digital functions). This requires having data storage with this data structure and content therein accessible to the designated application or the gestures' interpretation can be embedded inside the application or inside the device's operating-system. The database may be stored in data storage units of the user device(s) or on a remote server supporting thereof.

According to some embodiments of the invention, mnemonics-by-handwriting-gestures are input controls that derive actions in application or operating systems gesture driven actions, that the gestures that derive them are detected by gestures detecting methods, and those gestures are being processed to produce shapes and movements that can be recognized by human as text symbols, and then associated as mnemonics of human input commands or input controls relating to applications or operating systems commands that have the same initial letters or prefixes. Those gestures 3D trace have trajectories on a 2D coordinate system that can be considered in a similar way to drawing letters and words on a 2D paper, i.e. omitting the z axis, and then by using handwriting recognition techniques can be recognized))) and can produce recognized items such as a text of one letter or sequence of cursive or separated letters or a combination of separated and cursive letters of alpha-numeric letters, written in any human language, where handwriting means also printed English letters, in any variation of user's writing style, of any scale or in a pre-define range of scales, of any angle or in a pre-define range of angles in space, or but not limited to patterns that can be recognized and produce recognized items as symbols such as “@”, “&”, “<”, “>” and the like, or patterns that can be recognized and produce recognized items as known forms such as geometrical shapes or other known shapes such as rectangle, circle, triangle, trapezoid, star, asterisk, straight line, etc. The algorithm for gesture recognition can use the context of where and when these signs are performed via scenario based knowledge, for fine-tuning of the recognition process.

The mnemonics-by-handwriting-gestures, that were produced from gesture detection and recognition as alpha-numeric text or symbols or forms or any mixture of them, are letter or letters sequence or words in any known language, and are being interpreted as input controls in any application or specific application or any operating system or a specific operating system, by relating them to command or actions in applications or operating systems, whose identification or the prefix of their identification name is equal or can be correlated to the mnemonic. those actions can be but not limiting navigating to and then activating any operating systems' entity or web entity, for example but not limiting, gesturing the letter ‘w’ on touch screen or by moving hands in the air will activate in some cases the WORD application, those gesture driven actions can be but not limiting activate any command in any application working on any operating systems or web entity, for example but not limiting, gesturing the letter ‘s’ on touch screen or by moving hands in the air in the WORD application, will activate the save command in this application, or letting for example the recognition of the letter ‘b’ being drew in the air with a smartphone by processing movement sensors trace will lead to changing in the smartphone brightness, and in cases where the recognized items can be attributed to more than one navigated entity or action, the system will indicate the user on that and offer to his choice all possible activities, or ask him make a more complex gesture, for example but not limiting a gesture whose recognized item will be a longer prefix that will lead to unambiguous attribution.

According to some embodiments, there is provided a method which uses gesture recognition for allowing inputting gestures or sequences thereof to trigger computer functions equivalent to computer mouse functions such that the actual computer function executed depends on the gesture and characteristics thereof as well as on its respective context in relation to the computer status and/or previous computer functions.

According to some embodiments of the invention, there are provided systems and methods of gesture recognition for translating each dynamic and/or static gesture performed by the user into a computer mouse function and triggering an actual computer function thereby, according to a predefined translation rules in which each gesture is interpreted into a different mouse function optionally depending on the current state of the computer. This means that the characteristics of each gesture (e.g. period of holding the same posture of fingers or moving of the entire hand while holding the fingers in the same posture) is translated into a computer function typically now associated with a corresponding mouse operation. For example, a certain posture of the fingers of one hand of the user may be translated to an operation corresponding to an operation executed upon a single right click over the right button of the computer mouse, which can be interpreted into various computer functions depending on the status of the computer in the particular moment. For example, when a Word™ document is opened and one clicks over the right button of a mouse, a specific functions toolbar is opened for the user to select by moving the curser to the position over the screen in which the desired function is indicated and then clicking the left button of the mouse to execute this function. When using a different software such as “Excel™”, or when no software window is open, when the user clicks the right button of the mouse other toolbars are presented as known in the art. The present invention, in some embodiments thereof, provides a technique that can use the already programmed commands for translating the identified “mouse action” into the proper function in relation to the status of the computer while simply having a gesture recognition system and method replacing the signals arriving from the computer mouse. This means that a set of predefined gestures and characteristics thereof is translated into corresponding computer mouse activities or functions i.e. a first gesture is translated into a single click over the left right button; a second gesture is translated into a single click over the right mouse button; a third gesture is translated into a double click over the left mouse button; another third click pose or gesture is translated into determining an initial position of the curser; and a fourth gesture is translated to moving locating of the curser and the like.

The activation of a functionality may relate to the context of current use of an application such WORD application.

For example, gesture(s) that is designed for being translated into successive movement of the curser will require posing the hand/fingers in a fixed posture while moving the hand holding this posture for moving the curser, wherein the posture indicates that a curser movement is the desired function and the moving itself of the hand indicates the rout of the curser movement.

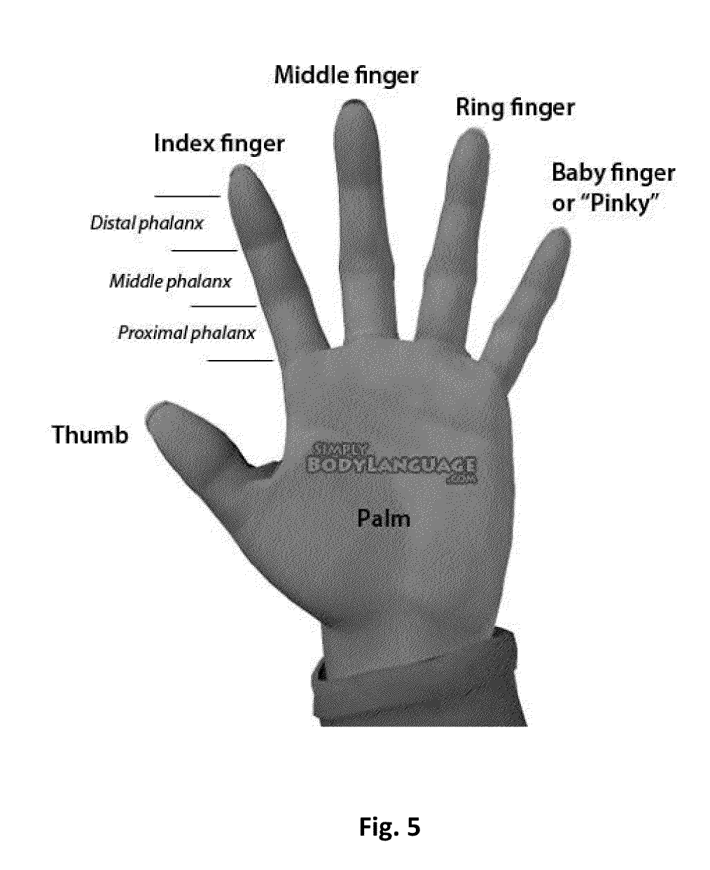

FIG. 5 shows a right human hand and its fingers.

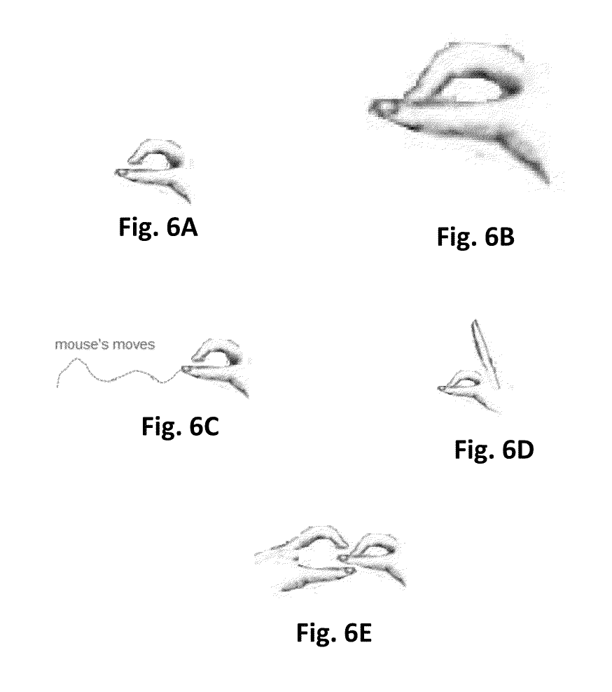

FIGS. 6A-6E show four different postures of the right hand translated into computer mouse functions: (i) an Open Klikegest posture in which the index finger is stretched outwardly, straight or slightly bent, over a fully stretched thumb, where the thumb and index finger tips do not engage one another, while all other fingers (i.e. the middle ring and pinky fingers) are in a clenched position or in an open position as shown in FIG. 6A. The Open Klikegest gesture is equivalent to moving the cursor on the screen; (ii) a Closed Klikegest posture in which the index finger is stretched outwardly slightly bent, over a fully stretched thumb, where the thumb and index finger tips engage one another, while all other fingers (i.e. the middle ring and pinky fingers) are in a clenched position as shown in FIG. 6B, or in an open position.

According to some embodiments of the invention, the Klikegest gesture can control a cursor spatial movement in an (x,y,z) coordinate system that its (x,y) dimensions are parallel to the (x,y) dimensions of the device's screen or perpendicular to the camera direction, or in angle that is in the range of few degrees from it, such as but not limited to 10 degrees.

According to some embodiments of the invention, the Open Klikegest can be translated into a pointing mouse action with a pointing vector that starts with the point that is located in the middle distance between the tips of the index finger and the thumb, or in any other nearby point that can be recognized by the camera, as but not limiting the center of the palm, and ends with a device's screen pointer that can present an (x,y) point or an (x,y,z) point.

According to some embodiments of the invention, a Moving Open Klikegest gesture is achieved by moving the hand while holding the fingers thereof in the Open Klikegest posture to any direction in space that can be translated to world model's (x,y,z) trace (curser moving) that moves the curser over the screen to the same direction as the Open Klikegest postured hand movement, similar but not limited to the moves of a 2D or 3D cursor moved by a mouse in the world model as shown in FIG. 6C.

According to some embodiments of the invention, depending on the world model and the context of a given application, the static Open Klikegest posture or dynamic Open Klikegest gesture can appropriately derive a pointing action or a world model's (x,y,z) trace when done by right hand or/and by left hand, and in case where these fundamental gestures driven actions can be derived (translated) only by one hand, the opposite hand then can derive another fundamental gestures driven action.

According to some embodiments of the invention, some gesture interpretation is made according to the sequence of gestures such depending on the previous gesture or action. For example, the Closed Klikegest i.e. when the index finger engages the thumb, can be translated to a simulation of mouse left click or/and an ENTER event, that can derive action such as selecting, hitting a button, etc., the click event will occur only when the user changes the gesture from an Open Klikegest to Closed Klikegest.

According to some embodiments of the invention, when performing the Closed Klikegest twice rapidly, i.e. when the index finger hits the thumb very fast twice, the translation of these actions can be a simulation of a mouse double-click or/and an ENTER clicking event, that can derive action such as but choosing a command in a toolbar menu, hitting a button, etc.

According to some embodiments of the invention, a Moving Closed Klikegest is achieved by moving the hand while the fingers are in the Closed Klikegest posture to any direction in space. This gesture can be translated to the world model's (x,y,z) trace of a left mouse button which one's presses and holds, which moves the curser over the screen to a corresponding direction to the movement direction of the hand, similar to dragging or marking in 2D or 3D cursor space in the world model as illustrated in FIG. 6C.

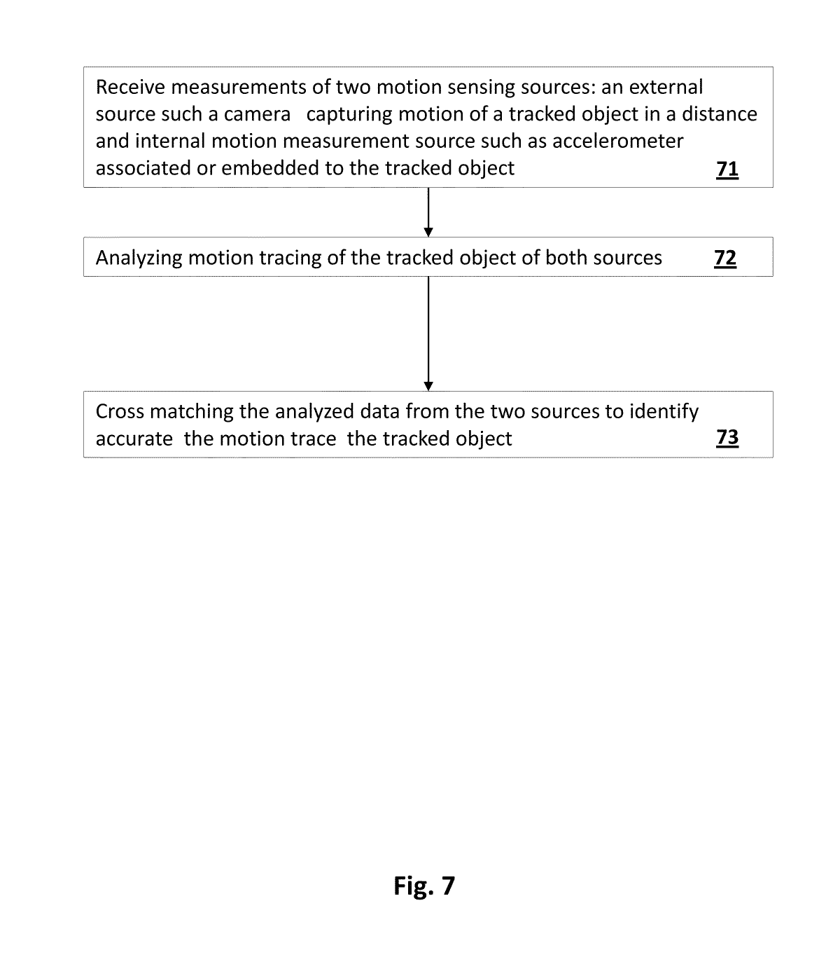

FIG. 7 is a flowchart schematically illustrating a process and method for cross-matching of single motion trace from different motion captures sources according to some embodiments of the present invention. The process of cross matching of motion trace of given object such as smartphone include the following steps : Receive measurements of two motion sensing sources: an external source such a camera capturing motion of a tracked object in a distance and internal motion measurement source such as accelerometer associated or embedded to the tracked object 711, analyzing motion tracing of the tracked object of both sources 712 and Cross matching the analyzed data from the two sources to identify accurate the motion trace the tracked object

According to some embodiments of the invention, changing the Closed Klikegest gesture to other or no gesture will cease any action this gesture derives, for example cease a dragging action and release the dragged item from hold.

According to some embodiments of the invention, depending on the world model and the context of a given application, the Closed Klikegest or Moving Closed Klikegest can appropriately derive an action equivalent to the right click mouse action or a world model's (x,y,z) trace with right click mouse pressed and hold, when done by right hand or/and by left hand, and in case where these fundamental gestures can be performed only by one hand, the opposite hand then can be used to trigger another action simultaneously and/or separately.

According to some embodiments of the invention, one or more gestures can trigger an action equivalent to mouse roller dragging action, mimicking a dynamic change in line's wideness of when drawing with a digitizer pen, mimicking a dynamic change when drawing of a digitizer pen's pressure, zooming-in or zooming-out world model, and/or fine-tuning (x,y,z) trace movement, i.e. moving a curser or any other pointer in shorter or longer intervals.

According to some embodiments of the invention, fundamental gestures can be all known gestures such as full hand that triggers for example zooming-in or zooming-out world model when moving hand closer or moving the hand further from the screen or camera, victory sign, thumb up or thumb down, etc.

According to some embodiments of the invention, fundamental gestures can be any combination of other fundamental gestures.

According to some embodiments of the invention, a Middle Finger Closed Klikegest is achieved by putting an index finger, over a fully stretched thumb engaging it in a pincers shape while the middle finger is stretched upwards and the ring and baby fingers are clenched as illustrated in FIG. 6D.

According to some embodiments of the invention, a Moving Middle Finger Closed Klikegest gesture is achieved by putting an index finger, over a fully stretched thumb engaging thereof, in a pincers shape such as shown in FIG. 6D while the middle finger is moving from a full open state to a bending position more closer the index finger, and the ring and baby fingers are still clenched.

According to some embodiments of the invention, a Moving Middle Finger Closed Klikegest is achieved when the hand itself is moving while held in the fixed posture, This gesture can trigger an action of drawing a spatial line whose width can be changed dynamically by changing the distance between the middle and the index finger.

According to some embodiments of the invention, a three Fingers Closed Klikegest gesture can be achieved by putting an index finger, over a fully stretched thumb engaging, where the tips of the thumb and index fingers engage one another in a pincers shape while the all other fingers are fully stretch.

According to some embodiments of the invention, a Wrapped Klikegests gesture can be achieved by holding one hand performing the Open or Closed Klikegest gesture, wrapped up by a full Open Klikegest gesture of the other hand, i.e. both hands are in the same 2D coordinate system, and one hand is making an Open Klikegest gesture with bigger distance between the index finger and the thumb than of the other hand that performs the Open or Closed Klikegest., as illustrated in FIG. 6E.

According to some embodiments of the invention, a Moving Wrapped Klikegests gesture can be achieved by having the user in a state where one hand performs Open or Closed Klikegest gesture, and the other hand is in the same 2D coordinate system as the first hand, but with Open Klikegest that has bigger distance between the index finger and the thumb than of the first hand, and both hands are far away from each other, and then the user moves one hand to reach the state of a Wrapped Klikegest gesture, while the other hand stays static.

According to some embodiments of the invention, a two Open Klikegests is achieved when the user has two hands in the same 2D coordinate system and they are both performs Open Klikegest gestures, and the hands are far away from each other.

According to some embodiments of the invention, a Moving Klikegest in one hand and a Full Hand pose done by the opposite hand that is moving towards the device's screen to perform a fine-tuning of (x,y,z) trace movement.

Appendix I enclosed herewith is hereby incorporated by reference to this application.

According to some embodiments of the invention, there is provided a method for using gesture recognition in graphical software tools for executing graphics actions such as virtual sculpturing of a 2D or 3D model image by moving the fingers in a certain manner and the like. For example, the model can be carved, sharpened, smoothened by using different fingers postures and moving the hand with each posture to carve, sharpen or smooth the outer sides of the model for instance.

Other manipulations can be made by using gestures and gesture recognition such as changing screen orientation (portrait or landscape), zooming in and out as mentioned above, scrolling, adding symbols to text messages such as smiley and the like all associated in the data storage and programming in relation to different gestures.

According to some embodiments of the invention, a backup algorithm for user identification is provided for cases where the user's devices (such as but not limited to smartphones, tablets, disk-on-keys, etc.) are not available or cannot be activated. In this case, the user can enter through a more long and complicated authentication process to approve his/her identity—this can include a sequence of local and “handshaking” authentication processes.

According to some embodiments of the invention, each pose or full gesture represents a letter or other symbol or sign in one or many gestures languages. Each gestures language has final or unlimited lexicon in a dictionary of gestures words. A word consists of one gesture letter or an ordered consecutive sequence of gestures letters. A “legal gesture word” is a one that exists in the gestures language's dictionary stored in a predefined database.

A “gestures sentence” consists of one gestures words or an ordered consecutive sequence of gestures words.

According to some embodiments of the invention, each gestures' letter/word/sentence/sentences represents an action in one or more world models that exist and are presented on screens of devices, where devices are controlled by a system that control also gestures processing and images capturing cameras.

According to some embodiments of the invention, the system processes the captures gesture letter/word/sentence/sentences performed by the user, and recognizes which gesture letter/word/sentence/sentences was inputted, and activates a gesture middleware sub-system/method that translates/decodes the recognized gesture letter/word/sentence/sentences input into gestures driven actions activated in the devices such as computer functions (e.g. open a specific program associated with the input word/sentence etc.) or computer functions associated with corresponding computer mouse actions such as right/left single/double click depending on the device status at the particular moment.

According to some embodiments of the invention, a gestures language and a specific world model dependent prediction system can offer a set of gestures or gestures driven actions, predicted after a one or a partial sequence of gestures. Therefore, an auto-completion process can be executed for automatically completing the word/sentence etc. associated with the partially inputted one.

According to some embodiments of the invention, a recognition of a single captured gesture can be done by “contextual recognition” when making assumptions on the recognition of its full context: this can be done by using system's recognition results of other gestures done before the currently identified gesture and their chronological order, or/and assumptions on the legal gesture word that consists this gesture as a gesture letter in the specific language, or assumptions on the possible gestures driven actions (which might represent in some non-limiting embodiments a smaller set of gestures words or sentences).

According to some embodiments of the invention, the contextual recognition can include statistical or heuristic procedures to recognize a given gesture and give few candidates as recognition results for each gesture in a given sequence of gestures, for example assuming that the user tries to write in the air forms of English—the first can be recognized as letter ‘o’ or ‘a’, the second as ‘c’, and the forth as ‘l’, or the last two gestures can be recognized as one gesture with ‘d’ as a result. The recognition procedure will give a different weight of gesture recognition accuracy level to each optional recognized sign/letter, then weigh the accumulated level of recognition for each possible sequence. i.e.: ‘ocl’, ‘ad’, ‘od’, ‘ad’, and chooses the sequence that has the maximal recognition level.

According to some embodiments of the invention, contextual recognition can be done for recognition of sign language and/or lip-reading decoding.

According to some embodiments of the invention, a gesture sentence will use one gesture as a “space gesture” meaning that the sign associated therewith is similar in meaning to a keyboard space sign i.e. marking the end of the word.

According to some embodiments of the invention, a gesture sentence recognition can be done when assuming a specific grammatical sentence structure specific to a given gesture language. For example if a first gesture word represents an adjective, the second gesture word is most likely to be a subject in many languages, the third gesture word is likely to be a conjunction word, the fourth represents another subject, the fifth predicate and the sixth represents an object.

According to some embodiments of the invention, there can be pre-defined set of expected grammatical sentence structures for each world model and gestures language and a default grammatical sentence structure consists for example, predicate and/or subject.

According to some embodiments of the invention, defining a set of expected grammatical sentence structure can be done for recognition of sign language and/or lip-reading gestures decoding.

According to some embodiments of the invention, when the dedicated application includes a keyboard with keyboard's screen for allowing the user performing the signs gestures and/or other audiences to view the identified signs. When screen pointer is on keyboard's screen, the user can perform a Moving Open Klikegest to move the pointer on the keyboard with any hand he chooses, both right and left hand, then can use the Closed Klikegest to click/ENTER on the button or square that contains a letter or letters, to input the letter to the inputting stream to the application, and if there are two letters on the same button, the click on the button or square with one specific hand will always be attributed as if the user clicks on the first letter and clicking with the second hand will always be attributed as if the user clicks on the second letter.

According to some embodiments of the invention, the system can guide and give feedback to the user in his process of commanding the right way of performing a gesture.

According to some embodiments of the invention, the system can learn the way a user performs a gesture and can adopt itself for a better recognition of the gesture when he makes this gesture again.

According to some embodiments of the invention, same or different gestures done in the same time by more than one user can be detected in parallel and processed using the contextual information of all users' interaction.

According to some embodiments of the invention, the Captcha solution to confirm that human and not automatic robot is the one that inputting an app or a site, can replace the text typing or voice inputting by gesture performing, and by this the ordinary people will have an easier way to confirm their being human, and people with disabilities such as blind people can follow system instructions to perform a gesture.

According to some embodiments of the invention, a prediction process suggests the user when being in a given state in a given application, a set of various future targets that the user can reach by using the application from this state, and the user chooses the one which is most similar to the target he has intended to reach, then the system or application suggests the user to proceed with one or various next UI move that can be gesture input, for example, table's layout in word processor, or 3d object in a 3d application, or a word prediction after writing a word prefix in a given language, the system will do the following process, moving the cursor to the next predicted letter, and the user can choose to click on it or to choose another letter to click on.

According to some embodiments of the invention, the process in the example of word in prediction in [0101] can be elaborated as, by sketching on the keyboard in advance, the various paths that can be derived from the prefix in this given language, and each path colors the keyboard in a different color, that can be covers the key space in ascending order, i.e. the last letter is fully colored and the intermediate letters are partially colored, with the user's option to click on the path the letter that fix the choosing of all its predecessors.

And as more explanations for the mnemonics: Compensating the limited human's memory capabilities by defining Mnemonics to navigate applications and activate internal commands—the text behind the mnemonics is acquired by capturing and recognizing handwriting gestures

Explanation: You can have the most natural/easy and functional gestures in the world, and your system (Camera+complex computational imaging) can be the greatest in recognizing them, and offers a library of thousand gestures, each is doing a needed or a cool function. Yet, the user must use his limited memory and the limited attention he reserves for practicing new tools and technologies, and try to command those gestures. This UX dilemma exist is similar to the one of offering 100% great features, that only 5-15% are in real use.

Klike's Mnemonics-by-handwriting-gestures implements our enormously great investment in Cursive Handwriting Recognition so that user is able to draw in the air . . . And she/he can do this as they are used to write separate letters or cursive sequence of letters, in their own style of form+trace/scale and speed.

According to some embodiments of the invention, one way to control cursor and control keys of applications or operating system on any device by gestures, is to have or/and to display control pad which is a smaller working area on a fixed or dynamic location on the screen that is dedicated for the work of those gestures that targeted for control and productivity purposes.

According to some embodiments of the invention, the control pad can have virtual keyboard keys or short-keys for any application or operating system that can be activated by gestures.

According to some embodiments of the invention, the control pad can have a cursor of its own that similar to a pad of a laptop, moving it by some gesture, will move to the same direction the cursor that moves in the application or the operating system. Moving the control pad's cursor in a fast movement can imply on the movement of the screen cursor to make a much bigger step in the same direction as of the control pad's cursor.

The method according to claims 11 to 12, wherein each gesture is a hand gesture illustrating a two-dimensional symbol, wherein each symbol or a sequence thereof is associated with a single general function, while the symbols can be written as printed or cursive style, as examples but not limiting , follows:
The symbol “w” can be associated with a function for opening a “WORD™” program;
The symbol “s” can be associated with a function of “save”;

The symbols “se” can be associated with a function of “search”;

The symbols “u” or “un” can be associated with a function of “underline”;

The symbols “t” or “tr” can be associated with a function of “translate”;

The symbols “b” or “bo” can be associated with a function of “bold”;

The symbol “e” can be associated with a function for opening a “Excel™” program;

The symbol “p” can be associated with a function for opening a “PowerPoint” program, or for the function of “paste”

The prefix “pa” can be associated with a function for opening a “paste” program, or for the function of “paste”

The symbol “f” can be associated with a function for opening a “Facebook” program;

The symbol “c” can be associated with a function of “close window” , or to the function “copy”;

And as like for symbols that are prefixes of names of applications and commands.

According to yet another aspect of the invention is provided a method for identification of motion tracking/tracing of an object. The method comprising the steps of: measuring motion of a single object motion by at least two motion capture sources: one motion capture source is a camera which captures the motion of the from distance and a second sensor, such as motion sensor which is associated, attached or embedded to said objection, receiving the at least two inputs simultaneously sensed and processing said received simultaneously sensed inputs for identifying at least one motion track/trace by cross-matching theses recorded inputs, said processing is carried out by using at least one computer processor.

The smart phone as implemented in the present invention can be used as a smart controller for a computer, TV , wearable computerized accessories, such as a watch, google glass, in virtual realty environment or augmented reality. Optionally the smart phone as implemented in the present invention can be used as interface for 3D software, such as gaming, animation, 3D design application, 3D printing application. In 3D design software, the smart phone enables to create, move and manipulate 3D models, activate function or emulating the mouse motion. The present invention utilizes the motion sensors embedded in phone for controlling the 3D design software.

According to some embodiments of the invention, user's details include among other data, user's unique parameters, which are parameters measured by sensors that can capture human input, and can be processed in real-time during or immediately after the capturing process, or stored in the system or processed and used off-line by using the stored data.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A method for user identification comprising the steps of:
a) receiving data from multiple sensing devices indicative of at least one gesture of a user;
b) identifying at least one gesture and at least one characteristic thereof from the data from each sensing device, using at least one gesture recognition analysis process; and
c) identifying a code associated with the user according to the identified at least one gesture and characteristics thereof,
said steps are carried out via at least one processor of at least one user device.

2. The method according to claim 1, wherein the user is required to carry out a predetermined sequence of multiple gestures, wherein each of these gestures of the users is sensed by a different sensing device according to the sequence in which they were performed by the user, wherein said identification of the gestures also comprises identification of the sequence of gestures and said code identification is based both on the gestures type and input sequence thereof.

3. The method according to claim 1 further comprising:
a) simultaneously sensing the same at least one gesture of the user by the sensing devices, wherein the identification of the code is done by identification of the gesture via at least one characteristic thereof; and
b) authenticating the identified at least one gesture from each sensing device by comparing the at least one gesture identified from each sensing device, wherein an authentication is valid only when the same at least one gesture is identified from all sensing devices.

4. The method according to claim 1, wherein each sensing device is operated through a different user device and the processing including said method steps is carried out at one of these user devices.

5. The method according to claim 4 further comprising transmitting data from the user device that does not carry out the processing to the user device that carries out the processing via at least one communication link

6. The method according to claim 1 further comprising visually and/or audibly presenting a set of instructions to the user

7. A method for identification of signs comprising the steps of:
a) sensing at least two types of inputs one of which is a physical gesture, said inputs are performed by a subject simultaneously, wherein said sensing is carried out by using at least one sensing device;
b) receiving the at least two inputs simultaneously sensed;
c) processing said received simultaneously sensed inputs for identifying at least one sign associated therewith by cross-matching theses recorded inputs, said processing is carried out by using at least one computer processor.

8. The method according to claim 7, wherein said identification of signs is used for automatic word and/or sentences identification and completion.

9. The method according to claim 7, wherein each of said inputs types comprises one of: body gesture, lips movement, hands movement, audio input, text input.

10. The method according to claim 7, wherein said signs comprise at least one of:
phonemes, syllables, words, sentences, symbols.

11. The method according to claim 7 further comprising visually and/or audibly presenting said identified sign or a sequential set thereof identified as a word over at least one screen.

12. The method of claim 7 wherein the sign is a personal signature.

13. A method of gesture recognition and translation comprising the steps of:
a) sensing gestures performed by a subject, using at least one sensing device;
b) recognizing each of the gestures by identifying characteristics of each sensed gesture;
c) identifying a computer function that is associated with the recognized gesture or with a sequence of recognized gestures in an injective manner; and
d) operating the identified computer function over a computer device,
wherein each identified gesture is translated into a computer function by at least one processor configured by operating a predefined set of computer commands of the associated function.

14. The method according to claim 11, wherein said identification of computer functions is carried out by using a database having a data structure in which each gesture or a sequence of gestures is associated with a specific single function in an injective manner.

15. The method according to claim 11, wherein gestures or sequences thereof trigger computer functions equivalent to computer mouse functions such that the actual computer function executed depends on the gesture and characteristics thereof as well as on its respective context in relation to the computer status and/or previous computer functions.

16. The method according to claim 11, wherein each gesture is a hand gesture illustrating a two-dimensional symbol, wherein each symbol or a sequence thereof is associated with a single general function , such as the symbol represent the name or unique prefix of the functionality.

17. The method according to claim 16 wherein the functionality relates to the context of current use of an application.

18. A method for identification of motion tracking/tracing of an object comprising the steps of:
a) measuring motion of a single object motion by at least two motion capture sources, wherein one motion capture source captures the motion of an object from distance said object and a second sensor is associated or attached or embedded to said object;
b) receiving the at least two inputs simultaneously sensed;
c) processing said received simultaneously sensed inputs for identifying at least one motion track/trace by cross-matching theses recorded inputs, said processing is carried out by using at least one computer processor.

19. The method of claim 18 wherein the motion tracing creates a personal signature.
